(19) United States
(12) Patent Application Publication
(10) Pub. No.: US 2004/0057439 A1
(43) Pub. Date: Mar. 25, 2004

(54) Hierarchical optical VPNs in a carrier's carrier VPN environment

(76) Inventor: Hamid Ould-Brahim, Kanata (CA)

Correspondence Address: Ridout & Maybee, LLP, 150 Metcalfe Street, 19th floor, Ottawa, ON, K2P 1P1, CA

(21) Appl. No.: 10/623,400

(22) Filed: Jul. 17, 2003

Related U.S. Application Data
(60) Provisional application No. 60/396,899, filed on Jul. 17, 2002.

(51) Int. Cl. H04L 12/28

(52) U.S. Cl. 370/400; 370/395.5

(57) ABSTRACT

A method of arranging, and a system of hierarchically arranged optical virtual private networks in a carrier's carrier virtual private network (VPN) are disclosed. The system has the hierarchical virtual private networks configured such that each VPN in the hierarchical network is affiliated to another VPN as a father or son VPN. Each son VPN has only one father VPN, and each father VPN is responsible for services and connections to its affiliated son VPNs. The system of hierarchical optical VPNs disclosed is particularly useful for allowing a carrier's carrier to provide the management functions for the clients of the carrier.

### RELATED U.S. APPLICATION DATA

Provisional application No. 60/396,899 filed on Jul. 17, 2002.

### FIELD OF THE INVENTION

The present invention relates to hierarchical optical VPNs (Virtual Private Networks) in a carrier's carrier VPN environment and is particularly concerned with allowing subscribers to an optical VPN service to provide optical VPN service to their customers.

### BACKGROUND OF THE INVENTION

A Virtual Private Network (VPN) may be thought of as a private network constructed within a public network infrastructure. Many definitions of VPNs can be considered:

Definition 1: A VPN is a set of users (devices attached to the network) sharing common membership information and intended to establish inter-site connectivity (within that group). A user can be a member of multiple groups (VPNs).

Definition 2: A VPN is a client private network that subscribes to restricted connectivity services.

Definition 3: A VPN is a service where a customer requests multi-site connectivity services provided through a shared network infrastructure.

Definition 4: A VPN is a service where a partition of internal provider network resources is allocated to a customer.

An Optical VPN (OVPN) may be considered a VPN including SONET/SDH technologies whose basic unit of service is an optical/TDM physical connection between two endpoints or sites.

In the network, carriers provide services to subscribers and, in turn, may be subscribers to other carriers' services. A carrier's carrier OVPN service is an Optical VPN service provided by a first carrier itself subscribing to an OVPN service from another second carrier. The carrier's carrier OVPN customer may decide to use its service to provide OVPN services or alternatively may decide to buy directly from the provider OVPN services to be used by his customers.

In the case where the customer does not or cannot manage the OPVN implementation and decides to outsource it to the provider, the provider will have to restrict connectivity for the client's client OVPNs in order to implement the OVPNs. This may be accomplished either directly through explicit intervention or indirectly by offering the customer the tools to manage its client while still reinforcing the OVPN architecture at the control plane.

Therefore, what is required is a scalable method or system which would allow the provider to support the customer's multiple OVPNs yet afford aspects such as simplified provisioning, overlapping addresses, constrained/restricted connectivity, on demand bandwidth requests, privacy/independence with respect to addressing and routing, and in general provide VPN services while achieving optical network efficiency and scalability.

### SUMMARY OF THE INVENTION

An object of the present invention is to provide an improved VPN in a carrier's carrier network.

According to a first aspect of the invention, there is disclosed a network having a set of elements interconnected by services; with at least one first subset of the elements defining a private network and at least one second subset of elements different from the first subset defining a provider network wherein at least two subgroups of the first subset of elements may be connected via the provider network. The network further has a services hierarchy wherein virtual private networks are defined on the second subset of elements. The services hierarchy includes a “father” virtual private network (VPN) and at least one affiliated “son” VPN. Each son VPN has at most one affiliated father VPN. Each father VPN is responsible for associating services and connections for the at least one affiliated son VPN and the provider network has a means for associating elements forming the father VPN.

According to another aspect of the invention, there is disclosed a method of organizing a network having a set of elements interconnected by services, wherein at least one first subset of the elements defining a private network and at least one second subset of elements different from the first subset defining a provider network wherein at least two subgroups of the first subset of elements may be connected via the provider network. The method includes establishing a services hierarchy wherein virtual private networks are defined on the second subset of elements. Further, there is established within the services hierarchy a father virtual private network (VPN) and at least one affiliated son VPN wherein each son VPN has at most one affiliated father VPN. Yet further, each father virtual private network is responsible for associating services and connections for the at least one affiliated son VPN; and providing a function for provider network associating elements comprising the father virtual private network.

Conveniently, the associating function for the provider network includes a VPN descriptor for each father VPN and each son VPN.

Advantageously, the associating function for the provider network may construct the VPN descriptors using an auto-discovery process.

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognise additional implementations, modifications, and embodiments which are within the scope of the present invention as disclosed and claimed herein.

### BRIEF DESCRIPTION OF THE DRAWINGS

The invention will be further understood from the following detailed description of embodiments of the invention and accompanying drawings, in which:

FIG. 1 is a diagram of a network reference model.

FIG. 2 is a diagram of an example carrier's carrier network.

FIG. 3 is a diagram of a carrier's carrier model Service Tree.

FIG. 4 is a diagram of an example Hierarchical Optical VPN Service Tree according to an embodiment of the invention.

FIG. 5 is a diagram of another example Hierarchical Optical VPN Service Tree according to an embodiment of the invention.

FIG. 6 is a diagram of an example Hierarchical Optical VPN according to an embodiment of the invention.

FIG. 7 is a diagram of an example Partition-based Hierarchical Optical VPN according to an embodiment of the invention.

FIG. 8 is a diagram of an example Hierarchical Optical VPN where the provider is managing a customer's OVPNs according to an embodiment of the invention.

FIG. 9 is a diagram of a HOVPN Service Tree with inactive levels according to an embodiment of the invention.

FIG. 10 is a diagram of a Service Tree showing possible operations according to an embodiment of the invention.

FIG. 11 is a diagram of the hierarchical relation of PITs (Port Information Table) in an HPIT (PIT Hierarchy Tree) according to an embodiment of the invention.

FIG. 12 is a diagram of an example HPIT Tree according to an embodiment of the invention.

FIG. 13 is a diagram of a HOVPN Policy Tree according to an embodiment of the invention.

FIG. 14 is a diagram of a GIT (Globally Unique Identifier Table) according to an embodiment of the invention.

FIG. 15 is an illustration of signaling used to establish connectively for a HOVPN according to an embodiment of the invention.

FIG. 16 is a diagram of a signal traversing a Service Tree according to an embodiment of the invention.

FIG. 17 is a diagram of a signal traversing a Service Tree and leaving a defined partition according to an embodiment of the invention.

FIG. 18 is a diagram of a service scenario with Auto-Discovery according to an embodiment of the invention.

FIG. 19 is a diagram of a service scenario showing a connection according to an embodiment of the invention.

### DETAILED DESCRIPTION

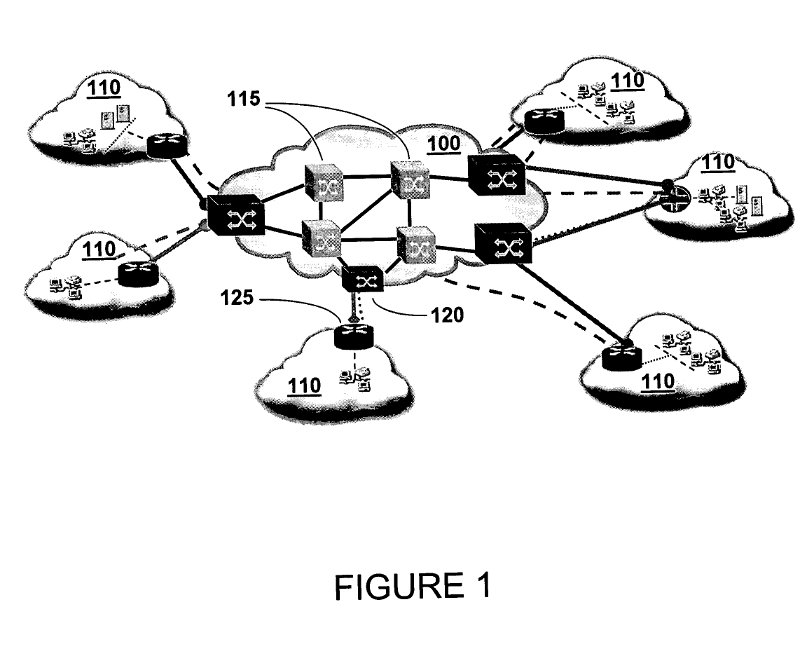

Referring to FIG. 1, there is illustrated a network having a Service Provider portion 100 with customer networks 110 connected to it. The Provider's network has network elements 115 and the portion of the Provider's network that interfaces with a particular customer network is a Provider Edge (PE) device 120. The portion of the customer's network which interfaces to the P E device 120 is a Customer Edge (CE) device 125. In this context, services means at least signalling or connectivity services.

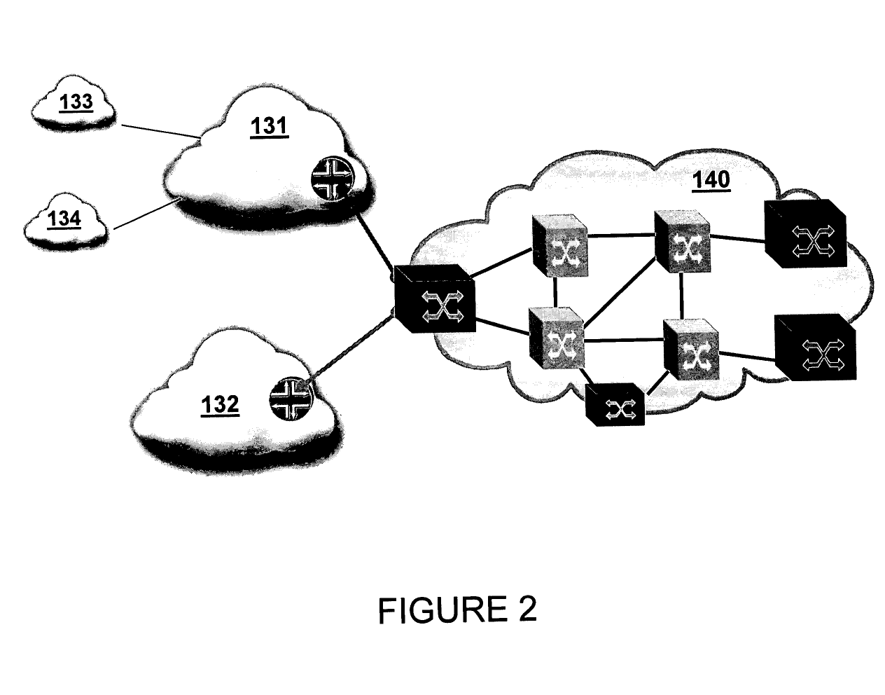

Referring to FIG. 2, there may be seen an illustration of an example carrier's carrier model service scenario. In this example, Client 1 131 and Client 2 132 each subscribes to a port-based Optical VPN from Provider A 140.

CLIENT 1 131 provides optical VPNs to Client 3 133 and Client 4 134 on the same Optical VPN (OVPN) bought by CLIENT 1 131. CLIENT 1 131 may decide that it would be preferable for Provider A 140 to provide all the OVPN functionality for CLIENT 1 131 OVPN customers.

In terms of addressing, CLIENT 1 131 may wish to use its own private addressing or use provider public addresses. CLIENT 3 133 and Client 4 134 may wish to use CLIENT 1 131 addresses or addresses provided by Provider A 140.

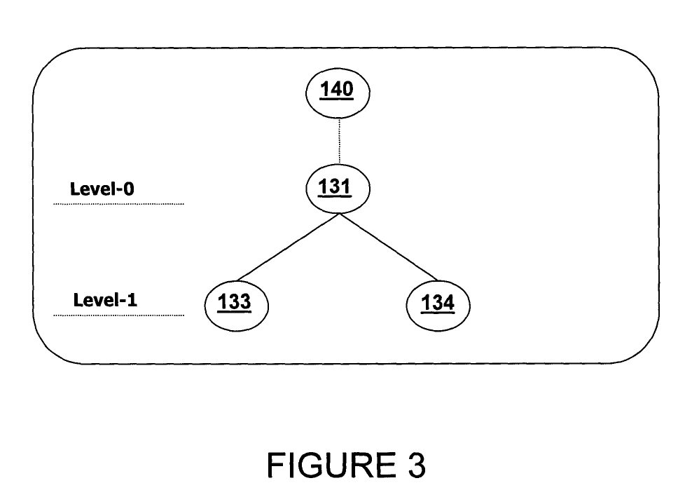

FIG. 3 is an alternative depiction of a portion of the service arrangement of FIG. 2 in the form of a service tree. It may be seen that Provider A 140 supplies services to CLIENT 1 131 who in turn provides services to Client 3 133 and Client 4 134.

A carrier's carrier OVPN service is an Optical VPN service provided by a carrier itself subscribing to an OVPN service from another carrier. An example would be Client 1 131 who is providing service to Client 3 133 while in turn subscribing to service from Provider A 140.

Hierarchical Optical Virtual Private N tworks (HOVPNs)

A Hierarchical Optical VPN (HOVPN) is an OVPN service associated with a hierarchical service tree. A hierarchical service tree is a tree of Optical VPN services involved in a hierarchy relationship.

A Hierarchical Port-based OVPN is a hierarchy of port-based OVPN where a father VPN may have one or more son VPNs. A given port may belong at most to one father OVPN.

Connections can be triggered by any son VPN within the father VPN and so on. On a given father port, multiple OVPN son memberships can be defined. The father port can only belong at most to one OVPN (including the extranet case). It is the role of the father VPN to associate at a given time the channel or connection to the son VPN.

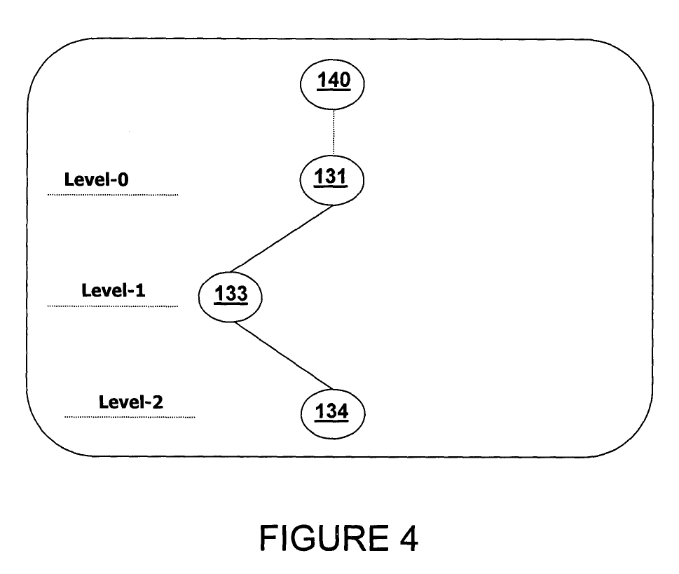

FIG. 4 illustrates a hierarchical service tree for the example network previously described. From the service tree Provider 140 provides services to father VPN 131 which services son VPN 133. In turn, son VPN 133 is father VPN to son VPN 134. For this service tree, the HOVPN father would be father VPN 131.

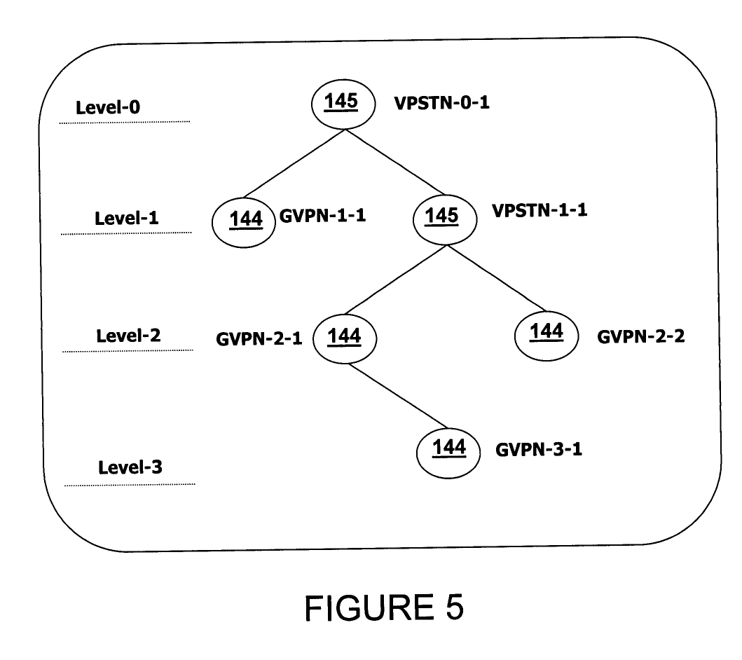

A Hierarchical Port/Partition-based OVPN is a hierarchy of a mixture of a partition and port-based OVPNs. In this context, a partition is a subgroup of services obtained from a Service Provider which would allow connectivity across the Provider network via the subgroup. FIG. 5 illustrates an example service tree containing both port-based OVPNs 144 and partition-based OVPNs 145. This particular tree illustrates an example case where a customer who subscribes to a partition-based VPSTN (Virtual Private Switched Transport Network, a type of partition-based service) decides to use this service to provide both GVPN (Generalized VPN, a port-based VPN service) and VPSTN services to its clients.

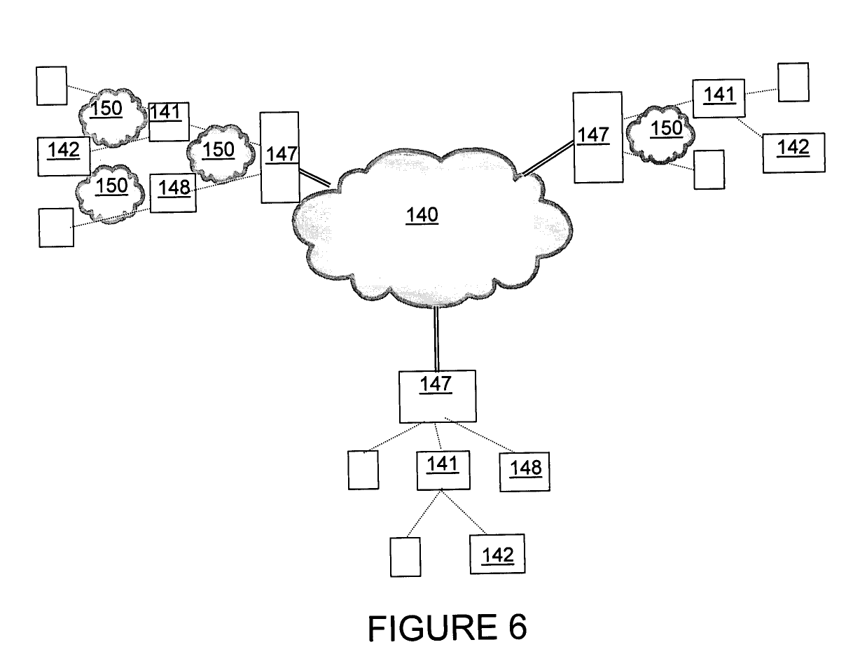

A Hierarchical Port-based OVPN may be considered a hierarchy of port-based OVPN where a father VPN may have one or more son VPNs. A given port may belong at most to one father OVPN. A Hierarchical Port/Partition-based OVPN is a hierarchy of a mixture of a partition and port-based OVPNs. Connections can be triggered by any son VPN within the father VPN. On a given father port multiple OVPN son memberships or affiliation may be defined. The father port can only belong at most to one OVPN (including the extranet case). It is the role of the father VPN to associate at a given time the channel/connection to the son OVPN. FIG. 6 illustrates an example HOVPN network according to this arrangement with Service Provider 140, father OVPN 147 and son OVPN 148. Note that several of the VPNs are connected via networks 150 which may be Metro networks, for example. The other VPNs 141, 142, and 143 which are part of the HOVPN network may also be seen.

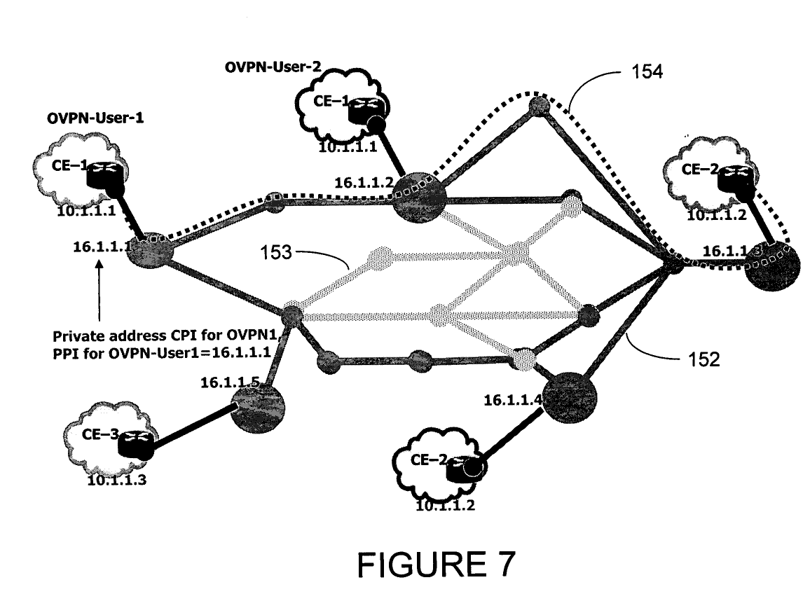

Referring to FIG. 7, there is illustrated a Partition-based HOVPN wherein may be seen the partition owned by the customer OVPN-1 152, the open partition 153, i.e., the Provider's network that is not part of the partition 152, and the connection 154 used for OVPN-User 1 through the partition OVPN-1 152.

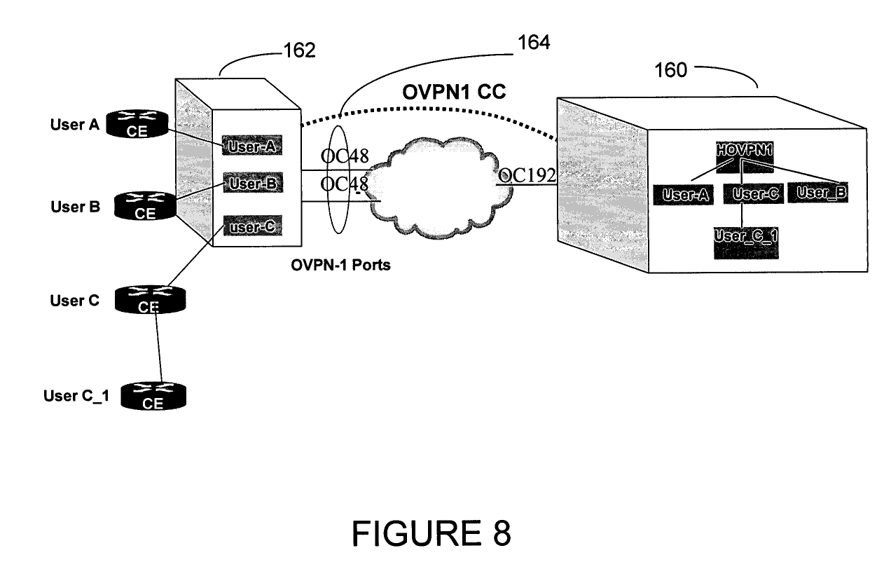

Referring to FIG. 8, there may be seen an HOVPN example of where the Provider is managing the customer's OVPNs. At PE 160, there is maintained a service tree of the services provided. The corresponding CE 162 may be seen as well as the father OVPN1 Control Channel 164. All the son VPN signalling information will traverse the father control channel.

For Port-based VPN, a given CE-USER can use the same port as the father OVPN (including the case where all the channels for the father OVPN port are all used by the OVPN “sons”). For Partition-based OVPN, the partition-based port can be used by multiple port-based OVPNs. On a given OVPN father port, multiple OVPN “son” memberships can be defined.

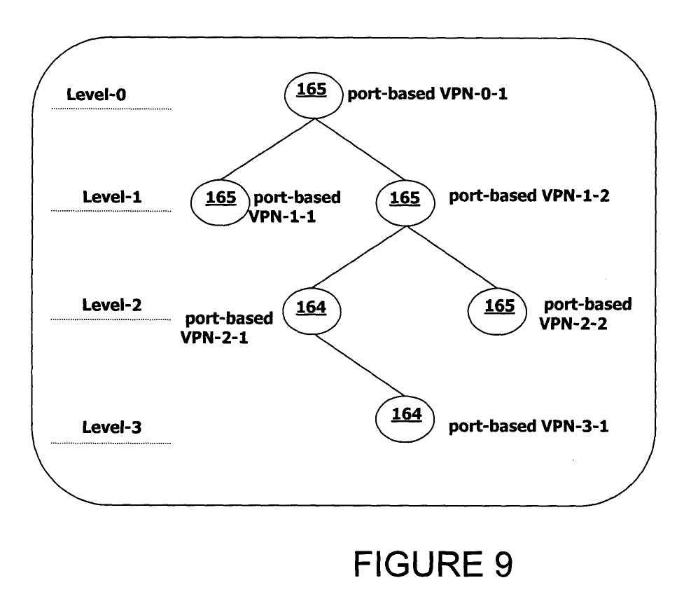

A given client or provider port may be assigned exclusively to one OVPN at any level within the hierarchy. It is apparent that being able to assign a given port to any level may result in inactive VPNs at levels in the hierarchy. FIG. 9 illustrates the service tree for this case where in-use VPNs 164 are hierarchically connected to inactive VPNs 165.

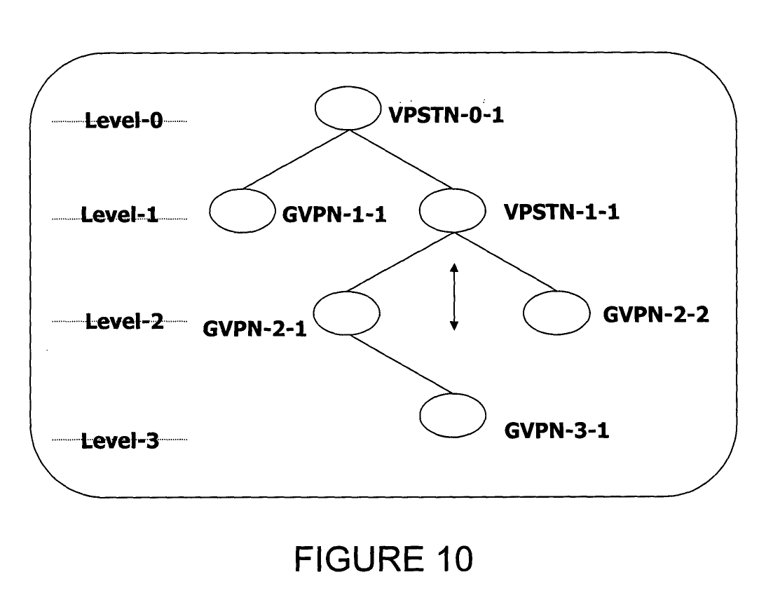

Referring to FIG. 10, it is apparent that certain operations may be performed on the service tree of an HOVPN which will change the network yet also preserve the hierarchical arrangement. Nodes in the service tree may be added, removed, promoted to a level-n, or demoted to a level-n with associated implications on VPN ownership and management.

Building Blocks of an HOVPN

OVPN Descriptor: contains information about each Optical VPN (part of an HOVPN).

Port Information Table (PIT): contains a list of Customer Port Identifier (CPI) and Provider Port Identifier (PPI) tuples for all the ports within an OVPN

PIT Hierarchy Tree (HPIT): contains a tree of HOVPNs composed of OVPN descriptors at different levels of a hierarchy

Global Unique Identifier (GID): One or more (VPN-IDs, Route Targets, etc.,) and can be allocated per OVPN basis.

GID Table (GIT): holds for each GID the correspondent OVPN descriptor information with its associated level.

In operation, each carrier's carrier OVPN when configured (i.e., a PIT is added and a port is allocated if it is a port-based OVPN) will be assigned a GID value unique across all OVPNs.

Details of an OVPN Descriptor on a Provider Edge

An OVPN descriptor (“OVPN Desc”) is associated with each Optical VPN service configured on the PE. The OVPN Desc contains (N.B.: see Glossary for terms used in the examples below):

The type of the OVPN service which can have one of the following values: GVPN_c=1, VPOXC_c=2, VPSTN_c=3, UNI based OVPN=4, others types may be defined later, for example, another flavour of port-based OVPNs.

OVPN Category=port-based, partition-based.

At least one GID associated with the OVPN. The same GID can be used for the same OVPN configured on multiple PEs.

Administrative Status value which can be set to “up”, “down”, or “testing”.

Operational Status value which can be set to “enabled” or “disabled”.

a Port Information Table (PIT): A PIT can be used with services like VPOXC and GVPN (VPSTN only when private routing is not used). A PIT will contain the following information:

a Customer Port Identifier (CPI);

a Provider Port Identifier (PPI);

Channel Characteristics; and

Local/AD constants: “AD” is CPI learned from auto-discovery, “Local” means learned from attached CE.

Example of OVPN Descriptor

GID=1234567

OVPN_Type=GVPN

OVPN_Category=Port_based

AdminStatus=Up

OperStatus=enabled

PIT={<10.1.1.1,16.1.1.1, info1, local>, <10.1.1.2, 16.1.1.2, info2, “AD”>, . . . }.

Combining OVPN Descriptors into a PIT Hierarchy Tree (HPIT)

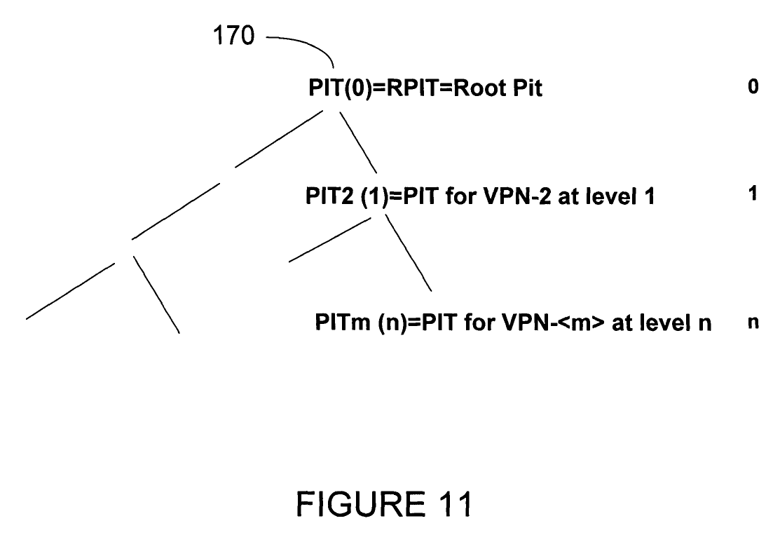

For each HOVPN is associated a hierarchical Port Information Table Tree (HPIT Tree). An example HPIT Tree is given in FIG. 11. An HPIT is hierarchical ordering of OVPN Descriptors.

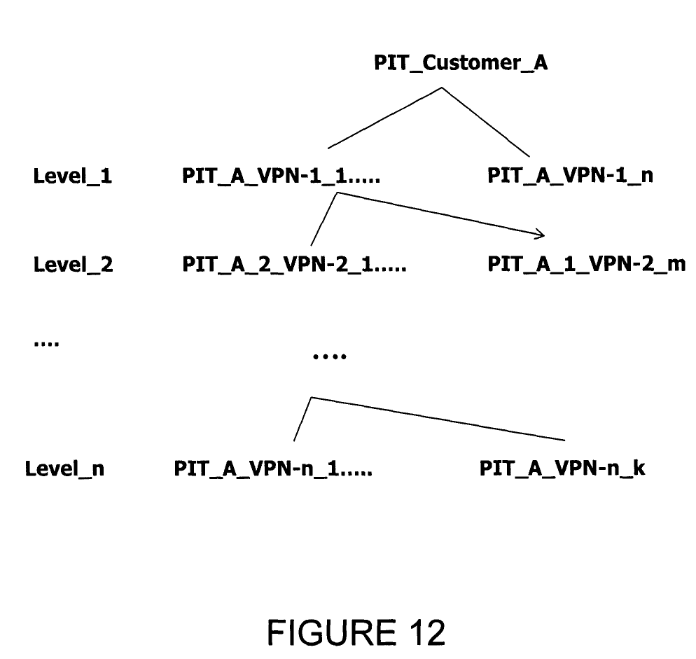

Referring to FIG. 11, a customer at level “0” (root of the HPIT tree) subscribes to a direct OVPN service. Therefore a PIT at the root of HPIT is considered the RPIT (Root Port Information Table). A Customer at level 2 subscribes to an OVPN service from an OVPN customer at level-1. A customer at level-n subscribes to an OVPN service at level (n-n where m≦n−1. FIG. 12 depicts a populated HPIT Tree according to an example embodiment.

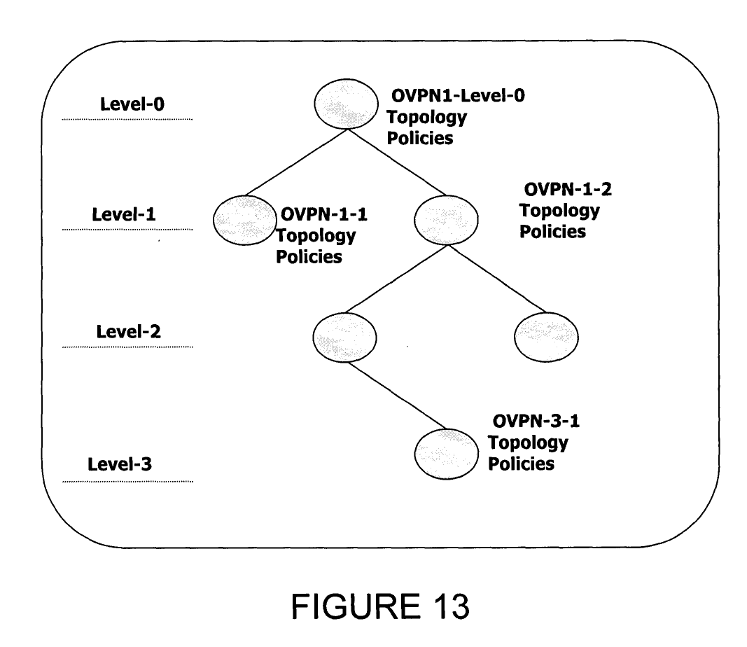

Referring to FIG. 13 it is apparent that the hierarchical nature allows for topology policies to be defined within each subhierarchy as connectivity is achieved through the hierarchy.

HPIT Rules

An OVPN service at level-n with a type=VPSTN can provide OVPN services at level (n+m where m=1, . . . k) of types VPSTN, VPOXC, GVPN and port-based UNI based OVPN.

An OVPN service at level-n with a type=port-based (GVPN) can only provide OVPN services at level (n+1, n+2, . . . , n+m) of type GVPN and UNI based OVPN.

An HPIT is associated with a list of import/export route targets taken from the list of route targets configured for each individual PIT.

A given CPI can be used by multiple OVPNs clients of the OVPN where the CPI belongs to. This CPI will be tagged with a list of export route targets coming from the sum of the list of route targets of each PIT where the CPI appears.

Since addressing is associated with ports on the provider edge, the network allows a VPN at level (n+m where 0<m) to use the same addressing defined by VPN at level-n. A private address at level-n is considered a public address at level (“n+1”. . . “n+m”).

According to another contemplated embodiment, another approach would be to allow each OVPN at each level to define and use its own addressing.

Note that this solution can be applicable to a network environment where public addresses are used at the root VPNs (an example protocol of which would be TNA (Transport Network Assigned Address) as in Optical Internetworking Forum UNi1.0 protocol).

Globally Unique Identifiers (GIDs)

Globally Unique Identifiers may be used in combination with HOVPNs to allow for auto-discovery mechanisms. The GID may include as well standard-based VPN-ID format as defined in the RFC2685 “Virtual Private Networks Identifier” B. Fox, B. Gleeson; September 1999,

An HOVPN may own multiple GIDs and multiple GIDs may represent the same HOVPN. The GIDs are used in the control plane to control the VPN membership of the connectivity service.

Example GID Format

Each GID is encoded as an eight-octet quantity:

Type Field: 1 or 2 octets

Value Field: Remaining octets

Typ Fi Id: The value of the high-order octet will determine if it is a regular type or extended type:

Type Field for regular types is 1 octet.

Type Field for extended types is 2 octets

The high-order octet of the Type Field is:

First bit (MSB):

IANA authority bit Value 0.

IANA assignable type Value 1

Second bit: Vendor-specific types.

Reserved Remaining 6 bits: Indicates the structure of the GID:

Value Field

The encoding of the Value Field dependents on the “type” of the GID as specified by the Type Field.

Four types defined.

Type 0×00: This is an extended type.

Administrator subfield: 2 octets, contains AS number

Assigned Number subfield: 4 octets, contains a number from a numbering space which is administered by the enterprise to which the ASN has been assigned by an appropriate authority.

Type 0×01: This is an extended type.

Administrator subfield: 4 octets, IP address

Assigned Number subfield: 2 octets, contains a number from a numbering space which is administered by the enterprise to which the IP address has been assigned.

Type 0×02: This is an extended type

Administrator subfield: 4 octets, contains AS number.

Assigned Number subfield: 2 octets, contains a number from a numbering space which is administered by the enterprise to which the IP address has been assigned.

Type 0×04: This is a regular type with a type field of 1 octet and a Value Field of 7 octets. The Value Field consists of two subfields:

Administrator subfield: 3 octets, contains a 3-octet Organizationally Unique Identifier, as defined by ANSI/IEEE. Assignment of OUIs is carried out by the IEEE OUI Registry.

Assigned Number subfield: 4 octets, the Assigned Number subfield contains a number from a numbering space which is administered by the enterprise to which the OUI has been assigned.

GIT Table

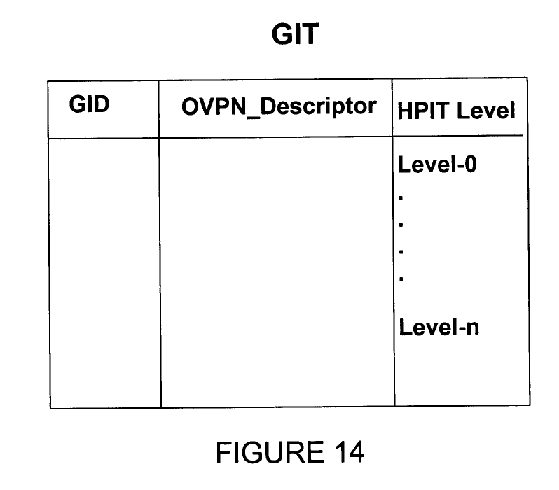

The GIT table is a table that holds the value of the Global Unique identifiers (GIDs) and their respective PIT (RPIT/HPIT). A GID table is indexed by HPIT levels. FIG. 14 depicts an unpopulated GIT Table.

Each HOVPN will be associated with:

an HPIT Tree;

a GIT Table; and

an OVPN Descriptor associated with the HOVPN.

Signalling

A customer of VPN at level (n+m) can signal optical connection requests provided by VPN service at level-n. For example, a VPN service at level-n is a VPSTN which can provide port-based Optical VPN at level (n+m), even if there is no connection used for OVPN at level (“n+1” . . . “n+m−1”) as per the previous discussion of inactive nodes.

There is the ability to signal a connection for VPN at level (n+m) using the VPN service provided at level-n.

For each VPN at level (“n+m”, m=1, . . . k), the connection request will carry the following items:

source_address (I), I=n, . . . ,n+m can be any address (private used by OVPN at level

destination_address(I),

Optionaly GID(n)> where I=0, . . . , n.

Should a GID not be specified in the connection request, the Root PIT will be used.

GMPLS based signaling may used (e.g., IETF-GMPLS, OIF-UNI1.0) although the solution described applies in general to any signaling protocol.

Connectivity Algorithm

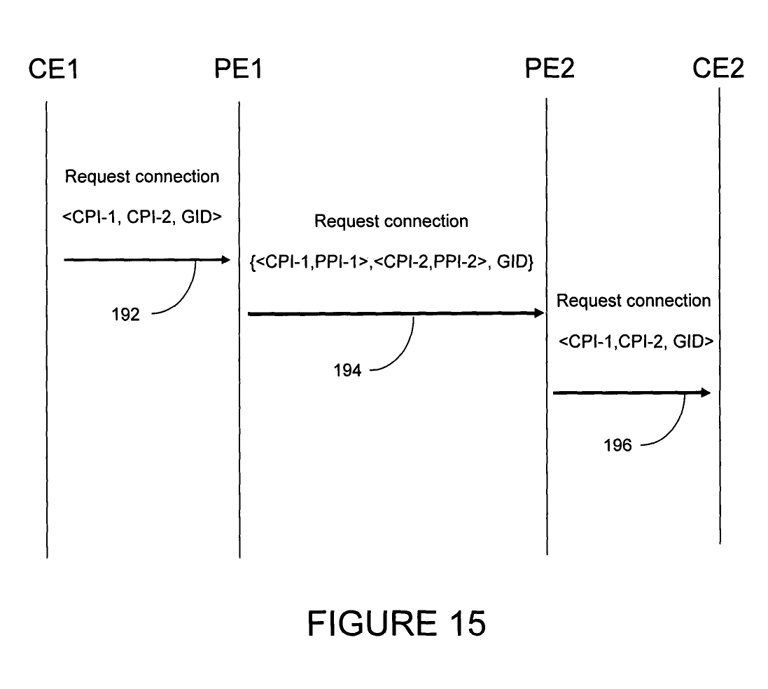

Following is the algorithm used to establish connectivity. Referring to FIG. 15:

1. At a PE1, a connection request 192 occurs with a GID as parameter.

2. Using the GID as a reference, obtains both the OVPN descriptor and the level of the OVPN (for example, level-n) from the GIT.

3. Ascertains the context of the customer as level-n using the level from the GIT and obtains the associated PPI by consulting the PIT(n) and checking the destination CPI. Formulates a connection request 194 between PEs using associated PPIs.

4. At PE2 formulates a connection request 196 completing the overall connection.

If no GID is present in original connection request 192, the connection is either for the root VPN or, alternatively, the connection is already set for a given port-based VPN within a given hierarchy (e.g., port-3 is associated with customer at level 3).

If there is no GIT table the call is cleared.

Signalling Traversing the Service Tree

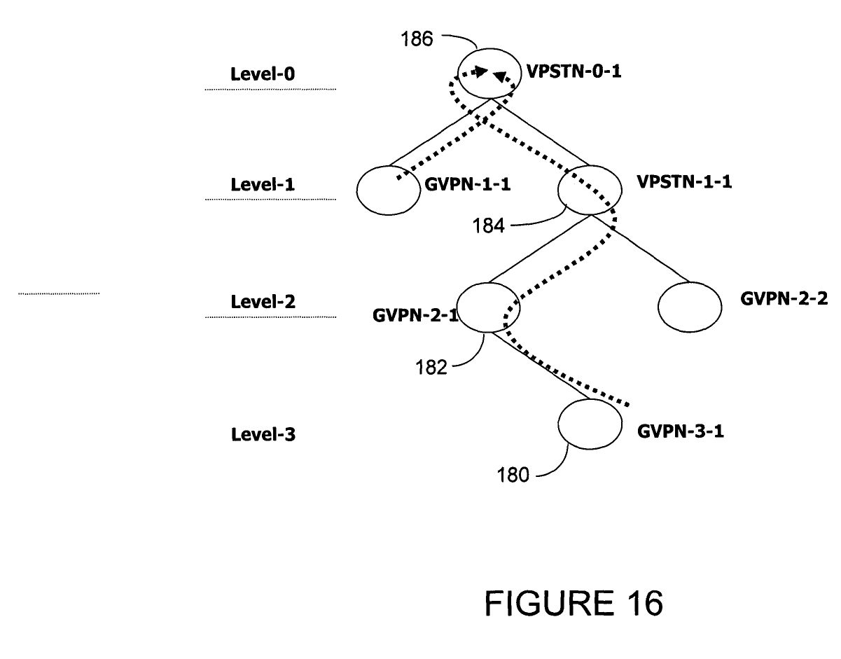

Referring to FIG. 16, connectivity signaling can traverse multiple OVPNs within the service tree. For example, GVPN-3 180 may signal connectivity that traverses GVPN-2 182, VPSTN1-1 184, and root VPSTN-0-1 186.

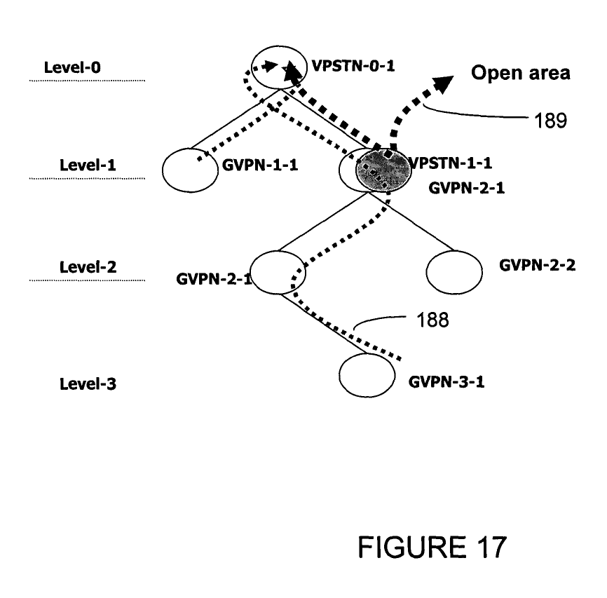

Referring to FIG. 17, when the same port is used for an HOVPN and other OVPNs (that include HOVPNs), then the customer can indicate through the use of GIDs what path the connection should take under various scenarios: the hierarchical tree path 188 or, alternatively, the open-area path 189. The latter case may be chosen in the case of a link failure on the partition, for example, allowing service to be maintained over the open network until the partition can be restored.

Auto-Discovery Mechanism

We may define a BGP-based auto-discovery mechanism that allows Client Devices (CDs) which are members of the same VPN to discover each other and request CD-to-CD optical connections across a service provider optical infrastructure. Note that the VPN auto-discovery mechanism is not limited to one based on BGP but that any suitable VPN auto-discovery mechanism may be used.

An Optical VPN (OVPN) is defined as a collection of ports that connect the Client Devices owned by the same organization to the service provider network.

A given service provider network may support multiple OVPNs.

A port may be considered as a collection of channels, for example, a lightpath, or a SDH/SONET circuit. Not all ports on a given Provider Edge Optical Network Element (PE-ONE) connecting that PE-ONE to Client Devices must belong to the same OVPN.

An important aspect is the support of single ended provisioning. It is possible to reconfigure an OVPN (e.g., when a Client Device request to set-up a new optical channel trail to another Client Device within the same VPN) without requiring configuration changes in any of the provider's ONEs.

Within a given OVPN, each port has an identifier unique only within that OVPN called the Customer Port Identifier (CPI). Within a service provider network, each port on a PE-ONE has an identifier that is unique within that service provider network. We refer to this identifier as Provider Port Identifier (PPI). Each PE-ONE maintains a Port Information Table (PIT) for each OVPN that has at least one port on that Provider Edge ONE. A PIT contains a list of <CPI, PPI> tuples for all the ports within its OVPN.

A PIT on a given PE-ONE is populated from two sources: the information received from the CDs attached to the ports on that PE-ONE, and the information received from other PE-ONEs (received, for example, through BGP).

Since the protocol used to populate a PIT with remote information is BGP and since GMPLS signaling is not restricted to a single routing domain, it is contemplated that this mechanism could support an environment consisting of multiple routing domains.

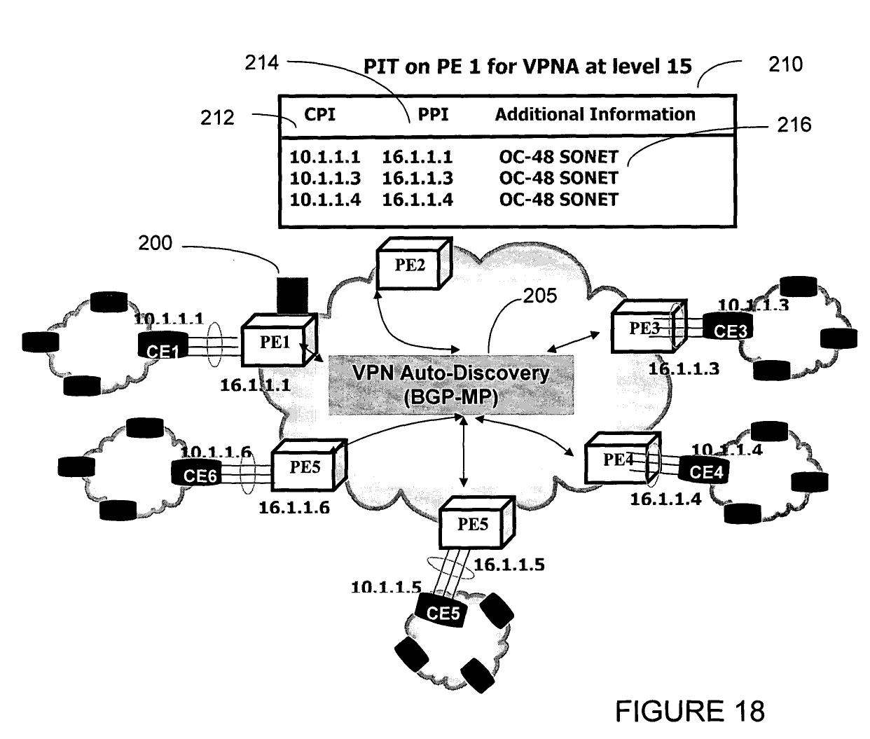

Referring to FIG. 18, an HPIT 200 is created for each HOVPN via VPN Auto-discovery 205. An example PIT 210 for PE1 illustrates the association of the CPI 212 and the PPI 214 as well as additional information 216.

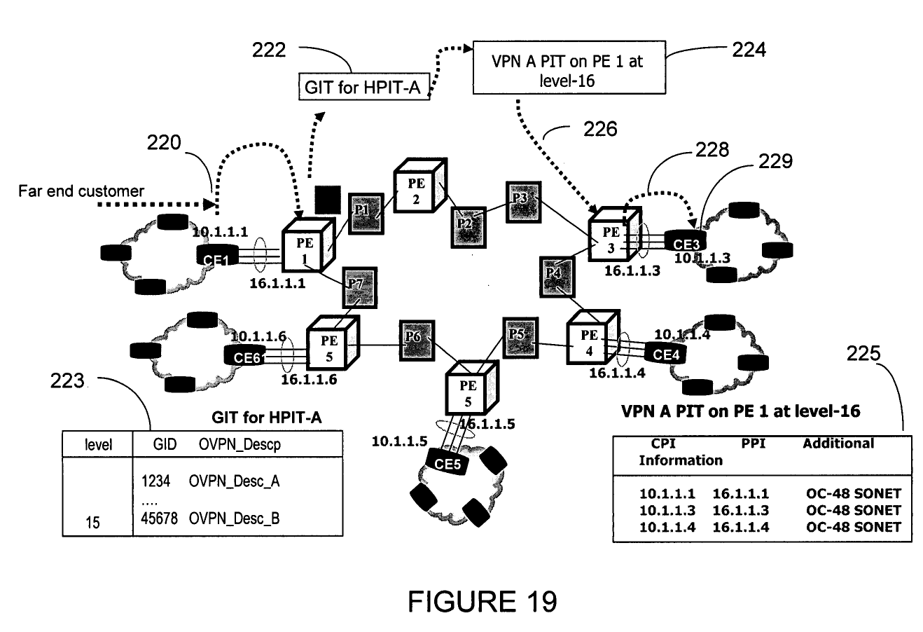

Referring to FIG. 19, a depiction of a connection across the network may be seen. The process initiates with a connection request 220 with the following criteria:

Connection request:

Source address=10.1.1.1,

Destination address=10.1.1.3

GID=45678

Recourse is made to the GIT 222 for determination of the OVPN descriptor (the example GIT is reproduced in more detail at 223). The OVPN descriptor allows recourse to VPN-A PIT on PE1 at level-16 224 for access of the tuple containing the relevant destination address in the provider network associated with the client destination address (the example VPN-A PIT is reproduced in more detail at 225). Accordingly, a connection request traversing the provider network using the PPI addresses is generated at 226 as:

Connection request:

Source address=16.1.1.1,

Destination address=16.1.1.3

The PE3 element receiving the connection request will formulate its own connection request 228 to the CE3 element as:

Connection request:

Source address=10.1.1.1,

Destination address=10.1.1.3,

GID=45678

The connection is then terminated upon the CE3 229 as desired in the original connection request.

Glossary of Acronyms Used

AD—Virtual Private Network Auto-Discovery

BGP—Border Gateway Protocol (an inter-autonomous system routing protocol)

BGP-MP—BGP Multi-protocol Extensions

CPI—Customer Port Identifier

GID—Globally Unique Identifier

GIT—Globally Unique Identifier Table

GVPN—Generalized VPN (a port-based Optical VPN service)

HOVPN—Hierarchical Optical VPNs

HPIT—PIT Hierarchy Tree

PIT—Port Information Table

PPI—Provider Port Identifier

RPIT—Root PIT

TNA—Transport Network Assigned Address

VPOXC—Virtual private Optical cross-Connect (a port-based VPN service).

VPSTN—Virtual Private Switched Transport Network (a partition-based VPN service)

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A network comprising:
a set of elements interconnected by services;
at least one first subset of said elements defining a private network;
at least one second subset of elements different from said first subset defining a provider network wherein at least two subgroups of said first subset of elements may be connected via said provider network;
a services hierarchy wherein virtual private networks are defined on said second subset of elements;
said services hierarchy comprising a father virtual private network and at least one affiliated son virtual private network;
each son virtual private network having at most one affiliated father virtual private network;
each father virtual private network responsible for associating services and responsible for associating connections for said at least one affiliated son virtual private network; and
said provider network having a means for associating elements comprising said father virtual private network.

2. A network as claimed in claim 1 wherein each said at least one affiliated son virtual private network may recursively act as a father virtual private network for a further virtual private network affiliated as a respective son.

3. A network as claimed in claim 1 wherein said means for associating elements comprising said father virtual private network includes a virtual private network descriptor for each father and each son virtual private network.

4. A network as claimed in claim 3 wherein said virtual private network descriptor contains an association between a n address of each element of said father virtual private network and an address of an element of said provider network for each case wherein said networks have direct port connections.

5. A network as claimed in claim 4 wherein said virtual private network descriptor for each father and each son virtual private network are grouped into a set of virtual private network descriptors arranged in a hierarchy, said hierarchy corresponding to a hierarchy defined by said father and said son virtual private networks' affiliations.

6. A network as claimed in claim 5 wherein said means for associating elements further comprises a globally unique identifier associated with said father or said son virtual private network.

7. A network as claimed in claim 6 wherein said means for associating elements further comprises a set associating for each said globally unique identifier a corresponding virtual private network descriptor and an indicator of a level within said hierarchy defined by said father and said son virtual private networks' affiliations.

8. A method of organizing a network having a set of elements interconnected by services, wherein at least one first subset of said elements defines a private network and at least one second subset of elements different from said first subset defines a provider network and wherein at least two subgroups of said first subset of elements may be connected via said provider network, said method comprising:
establishing a services hierarchy wherein virtual private networks are defined on said second subset of elements;
establishing within said services hierarchy a father virtual private network and at least one affiliated son virtual private network wherein each son virtual private network has at most one affiliated father virtual private network;
establishing each father virtual private network as responsible for associating services and responsible for associating connections for said at least one affiliated son virtual private network; and
providing a function for provider network associating elements comprising said father virtual private network.

9. A method as claimed in claim 8 comprising the additional step wherein each said at least one affiliated son virtual private network has an option of recursively establishing itself as a father virtual private network for a further virtual private network affiliated as a respective son.

10. A method as claimed in claim 8 wherein said function includes a virtual private network descriptor for each father and each son virtual private network.

11. A method as claimed in claim 10 wherein said virtual private network descriptor contains an association between an address of each element of said father virtual private network and an address of an element of said provider network for each case wherein said networks have direct port connections.

12. A method as claimed in claim 11 wherein said virtual private network descriptor for each father and each son virtual private network are grouped into a set of virtual private network descriptors arranged in a hierarchy, said hierarchy corresponding to a hierarchy defined by said father and said son virtual private networks' affiliations.

13. A method as claimed in claim 12 wherein said function further comprises a globally unique identifier associated with said father or said son virtual private network.

14. A method as claimed in claim 13 wherein said function further comprises a set associating for each said globally unique identifier a corresponding virtual private network descriptor and an indicator of a level within said hierarchy defined by said father and said son virtual private networks' affiliations.

15. A method as claimed in claim 14 wherein said set is established by a process of auto-discovery.

16. A method as claimed in claim 15 wherein said process of auto-discovery uses Border Gateway Protocol.

17. An element of a provider network according to the network of claim 1.

18. An element of a private network according to the network of claim 1.
